(19) United States
(12) Patent Application Publication
(10) Pub. No.: US 2017/0191446 A1
(43) Pub. Date: Jul. 6, 2017

(54) V-BLADE AND V-GROOVE JOINT MOLDED COMPOSITE WEAR EDGE GUARD

(71) Applicant: General Electric Company, Schenectady, NY (US)

(72) Inventors: Anthony John DURCHHOLZ, Loveland, OH (US); Michelle Ann BLACKBURN, Oxford, OH (US); Jordan Daniel ROBINSON, Warsaw (PL); John Andrew RAVENHALL, Hamilton, OH (US); Kamil SZEHIDEWICZ, Warsaw (PL); Carla Patricia HERNANDEZ LANGFORD, Loveland, OH (US)

(21) Appl. No.: 15/388,965

(22) Filed: Dec. 22, 2016

(30) Foreign Application Priority Data
Dec. 31, 2015 (PL) P.415487

(51) Int. Cl. F02K 1/76

(52) U.S. Cl. CPC F02K 1/766

(57) ABSTRACT

An annular molded composite wear sleeve (40) is bonded with epoxy or other bonding agent in an annular V-groove (34) in a groove ring (64). Wear sleeve (40) may include forward and aft sleeve walls (46, 48) extending at forward and aft sleeve obtuse angles (50, 52) away from a sleeve bottom (44) and may include annular forward and aft sleeve fillets (54, 56) between sleeve bottom (44) and forward and aft sleeve walls (46, 48). Aft sleeve wall (48) may include an aft flap (60) compliant with an annular aft taper (62) on groove ring (64). An aircraft gas turbine engine cowl clamping mechanism (22) for clamping a clamshell cowl (20) to a fan casing (26) includes groove ring (64) on a fan casing (26) and molded composite wear sleeve (40) bonded with epoxy or other bonding agent in annular V-groove (34) in groove ring (64). Annular V-blade (30) is on clamshell cowl (20) rotatable to insert annular V-blade (30) in annular V-groove (34).

### BACKGROUND OF THE INVENTION

Technical Field

The present invention relates generally to aircraft gas turbine engine cowls and, more specifically, to a V-blade and V-groove used to help keep the cowls closed.

Background Information

Aircraft bypass gas turbine engines typically employ thrust reversers for ground deceleration. The thrust reversers may be located in the fan bypass duct radially between an outer nacelle and an engine core cowl and axially between a fan and a fan nozzle. One type of thrust reverser envelops the engine around its circumference for the length of the reverser. For maintenance, to access the portion of the engine that is enveloped by the thrust reverser, the thrust reverser may be located within an outer cowling constructed as two clamshell structures that are pivoted from the pylon and can be opened when the engine is not in service.

The clamshells hinge upon the aircraft pylon with the forward end of the clamshell having a tongue-in-groove fit to the main engine that serves two purposes when the engine is operating. The first purpose is to seal the flow that is directed from the fan bypass into either the thrust reverser or fan nozzle. The second purpose is to provide support of the thrust reverser at its forward end. Typically, only a latch opposite the clamshell hinge holds the two halves of the clamshell together. This latch provides hoop integrity of the two clamshells during engine operation, but otherwise, does not further constrain the thrust reverser tongue (often called the V-Blade) in the engine groove (often called the V-groove). The tongue is often called a V-blade and is usually on the cowl and fits into the engine groove often called V-groove on an engine fan casing. Clamping apparatus incorporating knife-edges and mating grooves (similar to V-blades and corresponding V-grooves) have been used to secure or clamp the cowls.

There is often a lot of relative motion at an interface between the V-blade and V-groove due to the inherent flexibility of the thrust reverser clamshell halves, the lack of rigidity due to there only being two circumferential points of constraint of the clamshell halves, and the high vibratory environment induced by buffeting aero loads, especially during thrust reverser deployment. High contact stress and relative motion between these V-blade and V-groove structures necessitates a wear coating at a contact surface between the two in order to keep the two parts from excessively fretting each other, which can either dimensionally compromise the load carrying capacity of the joint and/or expose it to further deterioration by corrosion.

Some wear coatings at this joint have included metalized coatings of some sort such as Cu—Ni—IN or hard anodize usually applied to both the V-groove and V-blade. A more robust wear protection is desired to provide a longer life and greater durability.

### SUMMARY OF THE INVENTION

A clamping assembly (22) includes an annular molded composite wear sleeve (40) bonded with epoxy or other bonding agent in an annular V-groove (34) in a groove ring (64). The wear sleeve (40) may include forward and aft sleeve walls (46, 48) extending at forward and aft sleeve obtuse angles (50, 52) respectively away from a sleeve bottom (44) and annular forward and aft sleeve fillets (54, 56) may be between the sleeve bottom (44) and the forward and aft sleeve walls (46, 48). The aft sleeve wall (48) may include an aft flap (60) compliant with an annular aft taper (62) on the annular groove ring (64) containing the V-groove (34).

An aircraft gas turbine engine cowl clamping mechanism (22) for clamping a clamshell cowl (20) to a fan casing (26) includes the groove ring (64) on a fan casing (26) and the annular molded composite wear sleeve (40) bonded with epoxy or other bonding agent in the annular V-groove (34) in the groove ring (64). An annular V-blade (30) may be attached to the clamshell core engine cowl (20) which is rotatable to insert the annular V-blade (30) in the annular V-groove (34).

An aircraft turbofan gas turbine engine (10) includes a reverser (80) and a bypass duct extension (84) mounted to a clamshell core engine cowl (20) and radially spaced apart inner and outer cowl clamping mechanisms (90, 92) clamping radially spaced apart annular inner and outer duct walls (94, 96) of the bypass duct extension (84) to radially spaced apart annular inner and outer fan casings (100, 102) respectively of the engine (10). The inner and outer cowl clamping mechanisms (90, 92) include inner and outer V-blades (106, 108) on forward ends (110) of the inner and outer duct walls (94, 96) and inner and outer V-grooves (112, 114) in inner and outer groove rings (120, 122) on aft ends (116) of the inner and outer fan casings (100, 102) respectively. Annular inner and outer molded composite wear sleeves (40) are bonded with epoxy or other bonding agent in the inner and outer V-grooves (112, 114) respectively. The clamshell core engine cowl (20) may be rotatable for inserting the inner and outer V-blades (106, 108) in the inner and outer V-grooves (112, 114) respectively.

A method for preventing excessive fretting between annular V-blades (30) and mating annular V-grooves (34) in groove ring (64) includes bonding an annular molded composite wear sleeve (40) with epoxy or other bonding agent in the annular V-groove (34) in a groove ring (64) or on a matable V-blade (30). The method may include grit blasting or otherwise removing old and possibly corroded material from a V-groove surface (72) of the annular V-groove (34) before bonding the wear sleeve (40) in the V-groove (34). The method may include grit blasting down to bare metal of the V-groove surface (72) then coating the entire bare V-groove surface (72) with a structural bonding agent (74) that is resistant to corrosion.

The method may further include laying on the annular molded composite wear sleeve (40) and fitting the wear sleeve (40) to a three dimensional contour of the V-groove (34) such that essential points of contact for load transferal between the V-blade (30) and the V-groove (34) are formed after the coating of the entire bare V-groove surface (72) with the structural bonding agent (74). The method may be performed with the engine mounted on an aircraft.

### BRIEF DESCRIPTION OF THE DRAWINGS

The invention, in accordance with preferred and exemplary embodiments, is more particularly described in the following detailed description taken in conjunction with the accompanying drawings in which:

FIG. 1 is a perspective view illustration of an exemplary aircraft turbofan gas turbine engine with a cowl and a wear edge guard for a V-blade and V-groove cowl clamping mechanism.

FIG. 2 is an enlarged perspective view illustration of the exemplary aircraft turbofan gas turbine engine V-blade and V-groove clamping mechanism illustrated in FIG. 1.

FIG. 3 is a cross-sectional schematic view illustration of the exemplary aircraft turbofan gas turbine engine including a V-groove illustrated in FIG. 2 on the engine's fan case.

FIG. 4 is a cross-sectional schematic view illustration of a wear sleeve located between the V-blade and V-groove illustrated in FIG. 3.

FIG. 5 is a perspective view illustration of the wear sleeve illustrated in FIG. 4.

FIG. 6 is a cross-sectional schematic view illustration of an exemplary aircraft turbofan gas turbine engine with a cowl mounted reverser and radially inner and outer wear sleeves for inner and outer V-blade and V-groove cowl clamping mechanisms.

FIG. 7 is an enlarged cross-sectional schematic view illustration of view illustration of the radially inner and outer wear sleeves for the inner and outer V-blade and V-groove cowl clamping mechanisms illustrated in FIG. 6.

### DETAILED DESCRIPTION OF THE INVENTION

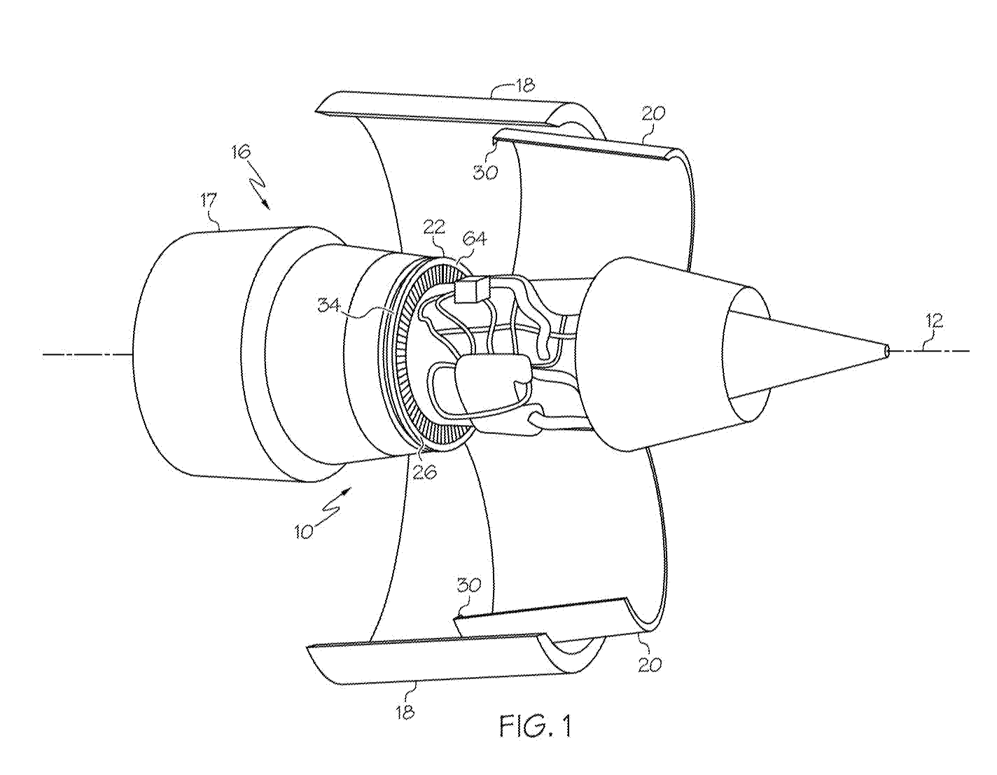

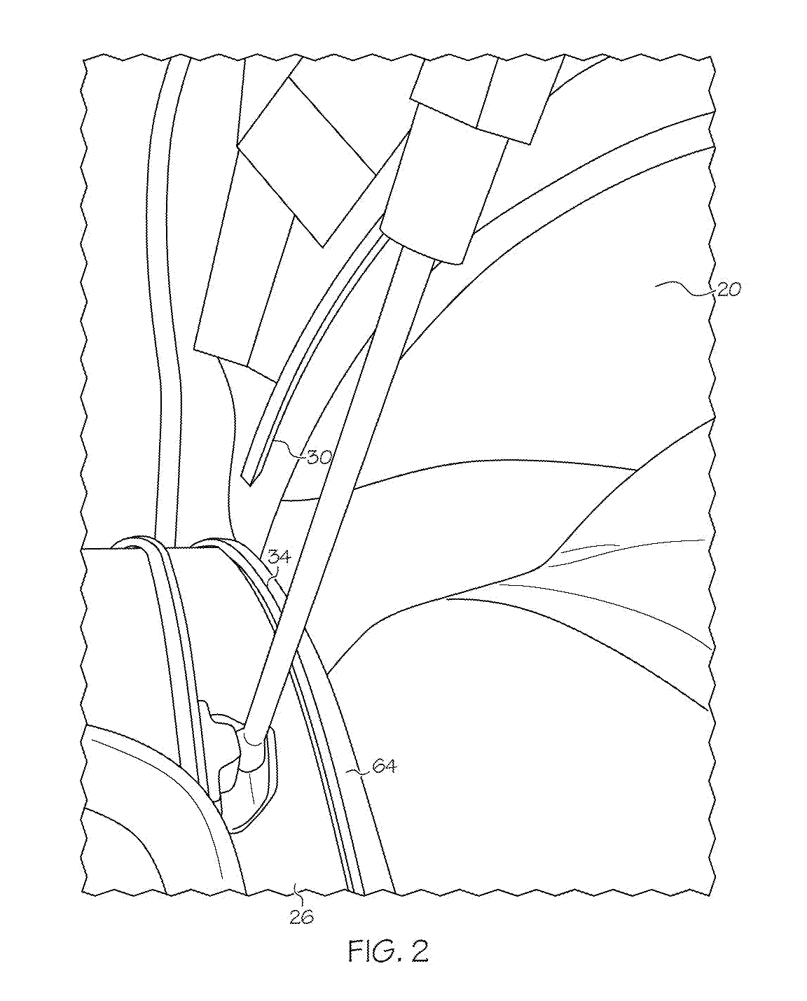

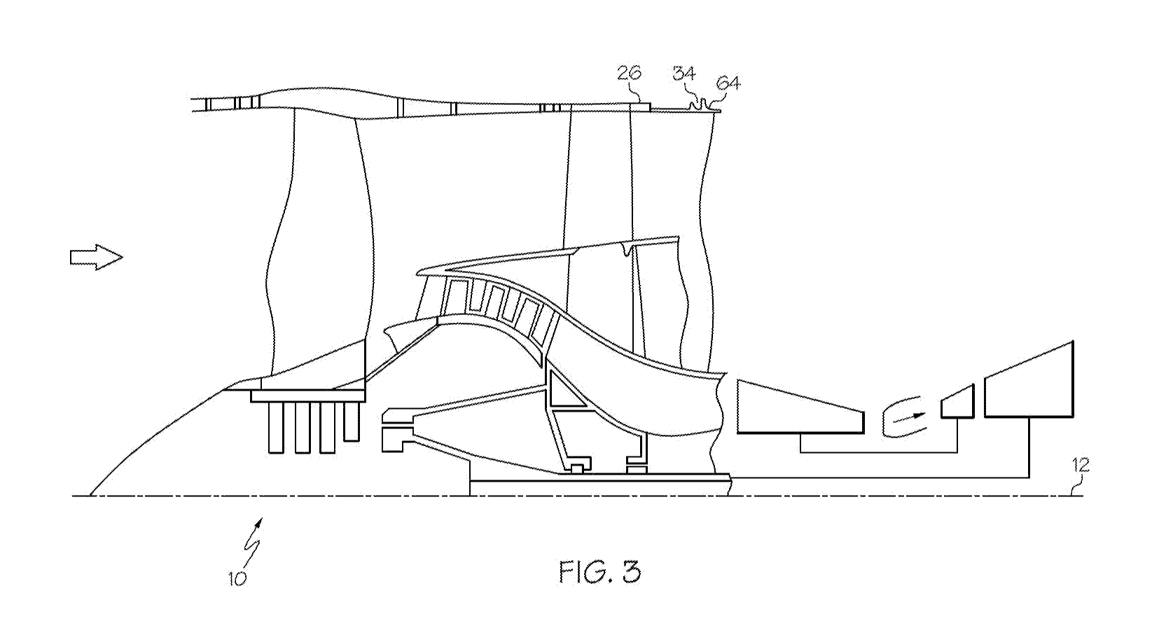

FIGS. 1-3 illustrates an exemplary aircraft gas turbine engine 10 for mounting on a support member or pylon, and a nacelle 16 generally circumscribing portions of the gas turbine engine 10 about a longitudinal centerline axis 12. The nacelle 16 includes an inlet 17 followed by a clamshell fan cowl 18. The nacelle 16 further includes clamshell core engine cowls 20 aft and downstream of the fan cowl 18 and is illustrated in FIG. 1 without a thrust reverser or bypass duct extension. A cowl clamping mechanism 22 for clamping the clamshell cowls 20 to a fan casing 26 of the engine 10 includes annular V-blades 30 on the clamshell core engine cowls 20 and annular V-grooves 34 in groove rings 64 on the fan casing 26 illustrated in greater detail in FIG. 2. Alternatively, the V-blades 30 may be on the fan casing 26 and V-grooves 34 in groove rings 64 on the clamshell cowls 20. The groove rings may also be made from non-metallic composite materials.

The V-blades 30 and the V-grooves 34 are annular and the V-blades 30 mate or fit into the V-grooves 34 when the clamshell core engine cowls 20 are rotated about hinges (not illustrated herein) and closed as is well known in the cowl field. When the clamshell cowls 20 are closed and the V-blades 30 are received in the V-grooves 34, there is often a lot of relative motion at this V-blade to V-groove interface 38 due to the inherent flexibility of the clamshell cowls 20 or other types of cowls used in aircraft engine nacelles. There is a lack of rigidity due to there only being two circumferential points of constraint of the clamshell cowl halves. This is also a highly vibratory environment induced by buffeting aero loads, especially during thrust reverser deployment.

The high contact stress and relative motion between the V-blades 30 in the V-grooves 34 has previously led to the adoption of metalized wear coatings, such as Cu—Ni—IN or hard anodize, on the contact surfaces of the V-blade to V-groove interface 38 in order to keep the two parts from excessively fretting each other. This fretting can dimensionally compromise the load carrying capacity of the clamping joint and/or expose it to further deterioration by corrosion. However, these metalized wear coatings still do not have adequate durability against this fretting and/or corrosion and must be refurbished many times within the normal life cycle of an engine.

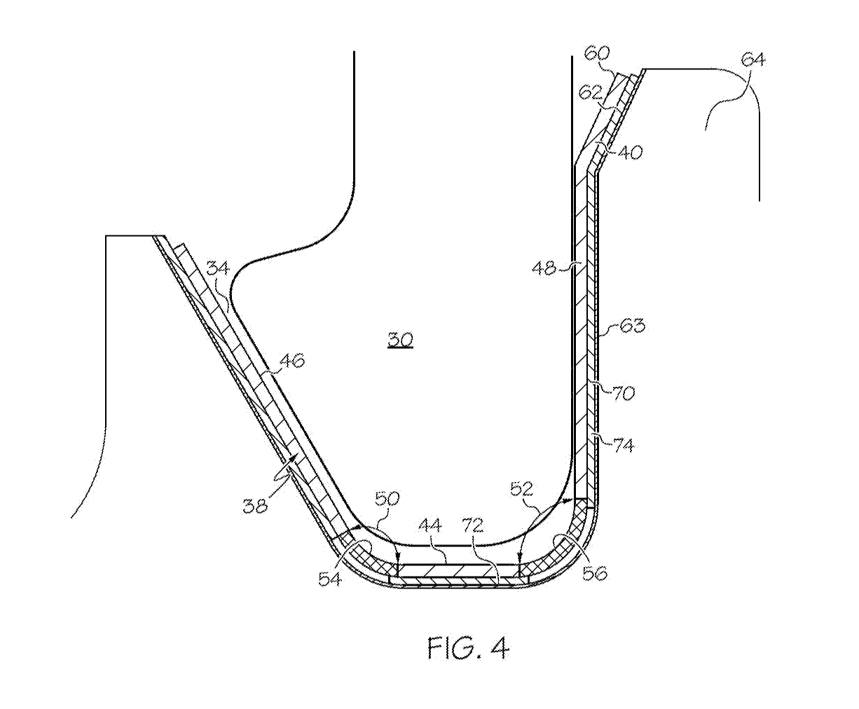

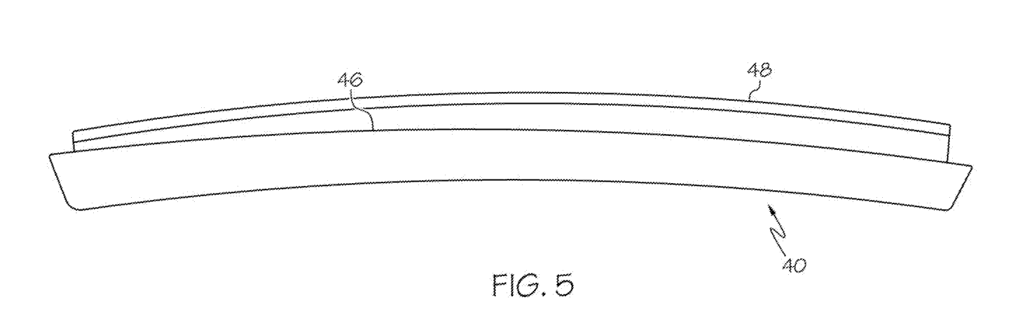

Disclosed herein and illustrated in FIGS. 4 and 5 is an annular molded composite wear sleeve 40 which may be bonded with epoxy or other bonding agent or otherwise attached into the V-groove 34 to serve as the wear material system to protect the V-blade to V-groove interface 38 from fretting and protect it from corrosion. The wear sleeve 40 provides a longer life than the coatings of the prior art. The wear sleeve 40 is sacrificial to the opposing wear coatings on the V-blade 30 so as to not jeopardize its wear durability. Alternatively, the composite wear sleeve could also be bonded to the V-blade 30 and the V-groove 34 may be coated with the metalized coatings. The clamshell core engine cowl 20 is rotatable for inserting the annular V-blade 30 in the annular V-groove 34.

The molded composite wear sleeve 40 illustrated in FIGS. 4-5 is annular having a sleeve bottom 44 and forward and aft sleeve walls 46, 48 extending at forward and aft sleeve obtuse angles 50, 52 respectively away from the sleeve bottom 44. Annular forward and aft sleeve fillets 54, 56 connect the sleeve bottom 44 to the forward and aft sleeve walls 46, 48 respectively. The aft sleeve wall 48 includes an aft flap 60 which complies with an aft taper 62 of the groove ring 64 which contains the V-groove 34. The aft taper 62 helps seat the V-blade 30 in the V-groove 34. The wear sleeve 40 is bonded to a substrate 63 such as the groove ring 64 with a bonding agent illustrated herein as a bonding layer 70 between the wear sleeve 40 and the groove ring 64 in FIG. 4.

The wear sleeve 40 may be a composite material including a Kevlar/Teflon weave, Fiberglass/Teflon weave, or other wear resistance weave coating. Examples of such materials are Dupont CP-0664, Kamatics Karon V, Kamatics P54, and Ultem 4001. The wear sleeve 40 may be made from a wear strips which are well known and are manufactured by companies such as Dupont and KAMATICS CORPORATION. DuPont's Vespel wear strips provide a suitable wear strip material for the wear sleeve 40. Vespel wear strips may be made from sheet-molded and fabric reinforced polyamide resin composite materials. The KAMATICS CORPORATION makes a wear strip material known as KAron wear strip material in the form of a fiberglass/epoxy backing of variable thickness with the KAron V liner system applied to one or both sides of the fiberglass. The KAron liner system is available in sheet or strip form and is well known for use in problem areas involving unintentional rubbing, scuffing or fretting.

The wear sleeve 40 may be bonded to the substrate 63 such as the groove ring 64 during new manufacture or as a repair or overhaul process. One exemplary method suitable for repair or refurbishment of the groove ring 64 includes grit blasting or otherwise removing old and possibly corroded material from a V-groove surface 72. The substrate 63 is grit blasted down to bare metal of the V-groove surface 72 then the entire bare V-groove surface 72 is coated with a structural bonding agent 74 that is resistant to corrosion. Then the molded wear sleeve 40 is laid on to the bonding agent 74 that fits a three dimensional (3D) contour of the V-groove 34 in such a way so that they form the essential points of contact for load transferal between the V-blade 30 and the V-groove 34. The bonding agent should be durable against the compressive and shear loads that the V-blade 30 transmits to the V-groove 34.

Suitable bonding agents include epoxy in liquid, paste, or film, or other adhesive types, that cures at room temperature or elevated temperatures and sufficiently bonds the wear sleeve in place so as to withstand the V-groove/blade loading and corrosive environment. Examples of such bonding agents include Hysol EA9394, Hysol EA9396, 3M AF3901 Film adhesive, 3M AF163 Film Adhesive, RTV/silicone rubber adhesives, Hyso19309, Hysol EA9460, 3M Scotchweld 460, and Araldite 2011. The repair or refurbishment method may be done with the engine still mounted on the aircraft such as on the wing or on an aircraft's fuselage.

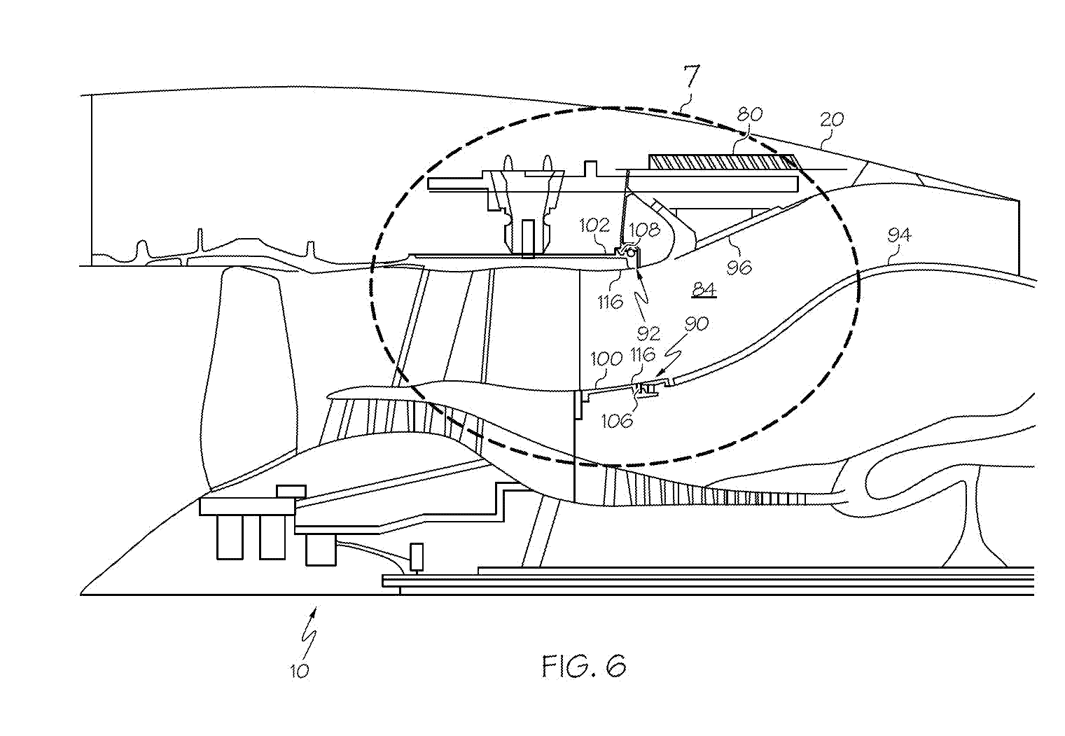

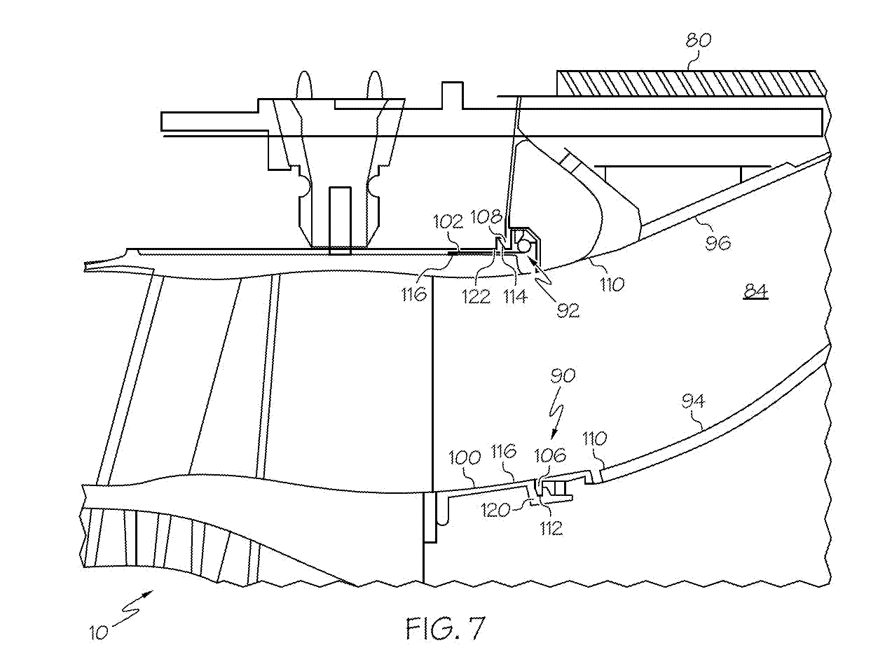

FIGS. 6 and 7 illustrate an exemplary aircraft turbofan gas turbine engine 10 with a cowl mounted reverser 80 and a bypass duct extension 84 mounted to a clamshell core engine cowl 20. Radially spaced apart inner and outer cowl clamping mechanisms 90, 92 clamp radially spaced apart annular inner and outer duct walls 94, 96 of the bypass duct extension 84 to radially spaced apart annular inner and outer fan casings 100, 102 respectively of the engine 10. The inner and outer cowl clamping mechanisms 90, 92 include inner and outer V-blades 106, 108 on forward ends 110 of the inner and outer duct walls 94, 96 and inner and outer V-grooves 112, 114 in inner and outer groove rings 120, 122 on aft ends 116 of the inner and outer fan casings 100, 102 respectively of the engine 10.

Molded composite wear sleeves 40 illustrated in FIGS. 4 and 5 and described above may be bonded in the inner and outer V-grooves 112, 114. The molded composite wear sleeves 40 are bonded with epoxy or other bonding agent or otherwise attached into the V-grooves to serve as the wear material system to protect V-blade to V-groove interfaces 38 from fretting. The groove ring 64 is attached to the fan casing 26 both of which may be made of metal or they both may be of a composite material. The V-blade 30 and the groove ring 64 which contains the V-groove 34 may be made from composite materials such as those made with woven composite matrix materials.

While there have been described herein what are considered to be preferred and exemplary embodiments of the present invention, other modifications of the invention shall be apparent to those skilled in the art from the teachings herein, and it is, therefore, desired to be secured in the appended claims all such modifications as fall within the true spirit and scope of the invention.

Accordingly, what is desired to be secured by Letters Patent of the United States is the invention as defined and differentiated in the following claims:

What is claimed is:

1. A clamping assembly (22) comprising an annular molded composite wear sleeve (40) bonded with epoxy or other bonding agent in an annular V-groove (34) in a groove ring (64).

2. The assembly (22) as claimed in claim 1, further comprising the wear sleeve (40) including forward and aft sleeve walls (46, 48) extending at forward and aft sleeve obtuse angles (50, 52) respectively away from a sleeve bottom (44).

3. The assembly (22) as claimed in claim 2 further comprising annular forward and aft sleeve fillets (54, 56) between the sleeve bottom (44) and the forward and aft sleeve walls (46, 48).

4. The assembly (22) as claimed in claim 3 further comprising the aft sleeve wall (48) including an aft flap (60) compliant with an annular aft taper (62) on the annular groove ring (64) containing the V-groove (34).

5. An aircraft gas turbine engine cowl clamping mechanism (22) for clamping a clamshell cowl (20) to a fan casing (26), the mechanism comprising a groove ring (64) on a fan casing (26) and an annular molded composite wear sleeve (40) bonded with epoxy or other bonding agent in an annular V-groove (34) in the groove ring (64).

6. The mechanism (22) as claimed in claim 5, further comprising the wear sleeve (40) including forward and aft sleeve walls (46, 48) extending at forward and aft sleeve obtuse angles (50, 52) respectively away from a sleeve bottom (44) and annular forward and aft sleeve fillets (54, 56) between the sleeve bottom (44) and the forward and aft sleeve walls (46, 48).

7. The mechanism (22) as claimed in claim 6 further comprising the aft sleeve wall (48) including an aft flap (60) compliant with an annular aft taper (62) on the annular groove ring (64) containing the V-groove (34).

8. The mechanism (22) as claimed in claim 7, further comprising an annular V-blade (30) on a clamshell core engine cowl (20) and the clamshell cowl (20) rotatable to insert the annular V-blade (30) in the annular V-groove (34).

9. An aircraft turbofan gas turbine engine (10) comprising:
a reverser (80) and a bypass duct extension (84) mounted to a clamshell core engine cowl (20),
radially spaced apart inner and outer cowl clamping mechanisms (90, 92) clamping radially spaced apart annular inner and outer duct walls (94, 96) of the bypass duct extension (84) to radially spaced apart annular inner and outer fan casings (100, 102) respectively of the engine (10),
the inner and outer cowl clamping mechanisms (90, 92) including inner and outer V-blades (106, 108) on forward ends (110) of the inner and outer duct walls (94, 96) and inner and outer V-grooves (112, 114) in inner and outer groove rings (120, 122) on aft ends (116) of the inner and outer fan casings (100, 102) respectively, and
annular inner and outer molded composite wear sleeves (40) bonded with epoxy or other bonding agent in the inner and outer V-grooves (112, 114) respectively.

10. An engine (10) as claimed in claim 9, further comprising each of the inner and outer wear sleeves (40) including forward and aft sleeve walls (46, 48) extending at forward and aft sleeve obtuse angles (50, 52) respectively away from a sleeve bottom (44) and annular forward and aft sleeve fillets (54, 56) between the sleeve bottom (44) and the forward and aft sleeve walls (46, 48).

11. An engine (10) as claimed in claim 10 further comprising the aft sleeve wall (48) including an aft flap (60) compliant with an annular aft taper (62) on each of the inner and outer groove rings (120, 122) containing the inner and outer V-grooves (112, 114) respectively.

12. An engine (10) as claimed in claim 11, further comprising the clamshell core engine cowl (20) rotatable to insert the inner and outer V-blades (106, 108) in the inner and outer V-grooves (112, 114) respectively.

13. A method for preventing excessive fretting between annular V-blades (30) and mating annular V-grooves (34) in groove ring (64), the method comprising bonding an annular molded composite wear sleeve (40) with epoxy or other bonding agent in the annular V-groove (34) in a groove ring (64) or on a matable V-blade (30).

14. The method as claimed in claim 13, further comprising grit blasting or otherwise removing old and possibly corroded material from a V-groove surface (72) of the annular V-groove (34) before bonding the wear sleeve (40) in the V-groove (34).

15. The method as claimed in claim 14, further comprising the grit blasting includes grit blasting down to bare metal of the V-groove surface (72) then coating the entire bare V-groove surface (72) with a structural bonding agent (74) that is resistant to corrosion.

16. The method as claimed in claim 13, further comprising laying on the annular molded composite wear sleeve (40) and fitting the wear sleeve (40) to a three dimensional contour of the V-groove (34) such that essential points of contact for load transferal between the V-blade (30) and the V-groove (34) are formed after the coating of the entire bare V-groove surface (72) with the structural bonding agent (74).

17. The method as claimed in claim 13, further comprising performing the method with the engine mounted on an aircraft.

18. The method as claimed in claim 17, further comprising grit blasting or otherwise removing old and possibly corroded material from a V-groove surface (72) of the annular V-groove (34) before bonding the wear sleeve (40) in the V-groove (34).

19. The method as claimed in claim 18, further comprising the grit blasting including grit blasting down to bare metal of the V-groove surface (72) then coating the entire bare V-groove surface (72) with a structural bonding agent (74) that is resistant to corrosion.

20. The method as claimed in claim 19, further comprising laying on the annular molded composite wear sleeve (40) and fitting the wear sleeve (40) to a three dimensional contour of the V-groove (34) such that essential points of contact for load transferal between the V-blade (30) and the V-groove (34) are formed after the coating of the entire bare V-groove surface (72) with the structural bonding agent (74).
